(19) United States
(12) Patent Application Publication
(10) Pub. No.: US 2024/0273273 A1
(43) Pub. Date: Aug. 15, 2024

(54) DISORDERED PARALLEL MAXIMUM FLOW/MINIMUM CUT METHOD IMPLEMENTED BY ENERGY-EFFICIENT FIELD-PROGRAMMABLE GATE ARRAY (FPGA)

(71) Applicant: SHANGHAITECH UNIVERSITY, Shanghai (CN)

(72) Inventors: Guangyao YAN, Shanghai (CN); Xinzhe LIU, Shanghai (CN); Yajun HA, Shanghai (CN); Hui WANG, Shanghai (CN)

(73) Assignee: SHANGHAITECH UNIVERSITY, Shanghai (CN)

(21) Appl. No.: 18/401,731

(22) Filed: Jan. 2, 2024

Related U.S. Application Data
(63) Continuation of application No. PCT/CN23/83558, filed on Mar. 24, 2023.

(30) Foreign Application Priority Data
Feb. 15, 2023 (CN) 202310121083.9

(51) Int. Cl. G06F 30/347; G06F 30/392; G06F 111/10; G06F 115/10

(52) U.S. Cl. CPC G06F 30/347; G06F 30/392; G06F 2111/10; G06F 2115/10

(57) ABSTRACT

A disordered parallel maximum flow/minimum cut method implemented by an energy-efficient field-programmable gate array (FPGA) folds a single-layer large two-dimensional grid graph into a multi-layer small grid graph. The method enables a folding grid architecture to store and process a grid graph that is much larger than a processor array in size. The folding grid architecture endows a two-dimensional processor array with a degree of freedom in a vertical direction, such that the two-dimensional processor array can leverage a potential for parallel performance of the folding grid architecture based on the degree of freedom in the vertical direction. The folding grid architecture enables a small-sized processor array to have an ability to process a grid graph that is much larger than the small-sized processor array in size. In addition, based on axial symmetry of folding, the folding grid architecture can greatly reduce cross-boundary transmission of data in the processor array.

### CROSS REFERENCE TO RELATED APPLICATION

This application is a continuation application of International Application No. PCT/CN2023/083558, filed on Mar. 24, 2023, which is based upon and claims priority to Chinese Patent Application No. 202310121083.9, filed on Feb. 15, 2023, the entire contents of which are incorporated herein by reference.

### TECHNICAL FIELD

The present disclosure relates to an implementation method of a high-speed and energy-efficient field-programmable gate array (FPGA) accelerator that adopts a maximum flow/minimum cut algorithm and can resolve a problem of cutting a large grid graph.

### BACKGROUND

A maximum flow/minimum cut algorithm is widely used in optimization tasks, such as neural network optimization [1], physical unclonable functions (PUFs) [2], compiler optimization [3], and computer vision tasks [4]. The previous works [5, 6] have explored acceleration of the maximum flow/minimum cut algorithm on a universal computing platform. During operation of a graph cutting algorithm, a large number of random dynamic random access memory (DRAM) accesses are generated, which cause a significant memory access delay and affects computing time. JF-cut [5] proposes a jump operation method and divides grid graph nodes into different parts in parity order, thereby alleviating a memory read/write conflict generated during parallel acceleration of a graphics processing unit (GPU). The reference [6] provides a buffer-friendly compact data storage structure for a multi-level memory model under the universal computing platform. When this data structure is used to compute the maximum flow/minimum cut algorithm for a grid graph, a performance loss caused by a memory access can be effectively reduced. However, in the maximum flow/minimum cut algorithm for the grid graph, due to a strong data dependency between adjacent nodes in the grid graph, a data dependency brought by an architecture cannot be completely alleviated under the universal computing platform. Therefore, even with a most advanced GPU platform, the universal computing platform is still unable to address a maximum flow/minimum cut problem of a large grid graph (including 1080×1920 nodes) quickly (at a speed of 60 frames). In addition, a huge energy consumption required by the universal computing platform is not allowed in the current work.

To address these problems, the current work uses a more flexible and efficient FPGA platform to accelerate such algorithms. The reference [7] provides an implementation of a most advanced maximum flow/minimum cut algorithm on the FPGA platform in recent years. The implementation comprehensively explores a potential for parallel performance in the grid graph. In the implementation, each computing node one-to-one corresponds to each node in the grid graph, and through checkerboard scheduling, all computing nodes can run the algorithm simultaneously without requiring additional time to handle or wait for a data conflict. In addition, a “RipplePush” method is also proposed to further improve the parallel performance during the operation of the maximum flow/minimum cut algorithm. Moreover, an “EarlyTermination” technology is used to reduce redundant computing in a computing process from an algorithm dimension and accelerate convergence time of the algorithm.

However, in the reference [7], because an architecture in which computing nodes one-to-one correspond to nodes in the grid graph is used, a large number of FPGA resources are used, making it impossible to process the large grid graph (including 1080×1920 nodes).

### CITED REFERENCES

[1] J. Li, M. Peng, Q. Li, M. Peng, and M. Yuan, “Glite: A fast and efficientautomatic graph-level optimizer for large-scale dnns,” in Proceedings of the 59th ACM/IEEE Design Automation Conference (DAC '22). NewYork, NY, USA: Association for Computing Machinery, 2022, p. 199-204.
[2] M. Li, J. Miao, K. Zhong, and D. Z. Pan, “Practical public puf enabled by solving max-flow problem on chip,” in Proceedings of the 53rd Annual Design Automation Conference (DAC '16). New York, NY, USA: Association for Computing Machinery, 2016.
[3]S. Reder and J. Becker, “Wcet-aware code generation and communication optimization for parallelizing compilers,” in Proceedings of the 23rd Conference on Design, Automation and Test in Europe, ser. DATE '20.
[4] P. M. Jensen, N. Jeppesen, A. B. Dahl, and V. A. Dahl, “Review of serial and parallel min-cut/max-flow algorithms for computer vision,” IEEETransactions on Pattern Analysis and Machine Intelligence, pp. 1-1, 2022.
[5] Y. Peng, L. Chen, F. X. Ou-Yang, W. Chen, and J. H. Yong, “JF-cut:A parallel graph cut approach for large-scale image and video,” IEEETransactions on Image Processing, vol. 24, no. 2, pp. 655-666, 2015.
[6] O. Jamriska, D. S' ykora, and A. Hornung, “Cache-efficient graph cuts on structured grids,” in 2012 IEEE Conference on Computer Vision and PatternRecognition, 2012, pp. 3673-3680.
[7] G. Yan, X. Liu, F. Chen, H. Wang, and Y. Ha, “Ultra-fast fpga implementation of graph cut algorithm with ripple push and early termination,” IEEETransactions on Circuits and Systems I: Regular Papers, vol. 69, no. 4, pp. 1532-1545, 2022.

### SUMMARY

The present disclosure is intended to provide a high-speed and energy-efficient FPGA accelerator implementation method that adopts a maximum flow/minimum cut algorithm and can resolve a problem of cutting a large grid graph.

In order to achieve the above objective, technical solutions of the present disclosure provide a disordered parallel maximum flow/minimum cut method implemented by an energy-efficient FPGA, including the following steps:

step 1: preprocessing a grid graph based on a size of a processor array to obtain a folding grid data structure, and setting (H, W) to a size of the grid graph, (h, w) to a size of the processor array, and (X, Y) to coordinates of a node in the grid graph, where X∈[1, H], and Y∈[1, W], such that the preprocessing includes the following steps:

step 101: converting the coordinates (X, Y) of the node in the grid graph into coordinates (x, y) in a coordinate system of the processor array, where x∈[1, h] and y∈[1, w]; and after the coordinate conversion, folding all nodes in a large grid graph and mapping all the nodes onto a multi-layer small grid graph that has a same size as the processor array; and

step 102: based on the converted node coordinates in the coordinate system of the processor array, inputting data of the multi-layer small grid graph obtained in the step 101 into an accelerator, storing a grid graph node corresponding to the same coordinates in a same processor, and inputting (h, w), ceil(X/h), and ceil as parameters, where ceil(Y/w) represents an operation of returning a minimum integer greater than or equal to a, the (h, w) is used to initialize a specific clock delay in an input/output process of the accelerator, the ceil(X/h) and the ceil(Y/w) are used to determine whether currently processed node data is mirrored, and coordinates [ceil (X/h), ceil(Y/w)] are used to represent a specific layer of the multi-layer small grid graph;

step 2: storing following data of each node in the multi-layer small grid graph in a corresponding processor in order of coordinates of the processor array in an input stage: ef data about a maximum flow that the node accommodates, edge data about a capacity of an edge pointing to a surrounding node, node height data (h data), and sink data about a capacity of an edge pointing to a virtual sink; and after the accelerator loads all the data, performing a global relabel operation, where a processor unit adopts a first in first out (FIFO)-based disordered execution technology to process each layer of the small grid graph, where

in the FIFO-based disordered execution technology, the performing a global relabel operation includes: traversing all nodes in the small grid graph; if sink data about a capacity of a node in the small grid graph is not 0, initializing the node as a seed point, placing all seed points in a FIFO queue, taking one node from the FIFO queue each time for computing, and updating h data of a current node to a height read from the FIFO queue plus 1; if edge data about a capacity of an edge that is of the current node and points to a buffer node in the FIFO queue is greater than 0, growing the node; when FIFO queues in all processor nodes are empty, completing the global relabel operation; and in an execution process, if ef data in a node is greater than 0, storing the node in a pending FIFO queue of a push operation in a next step; and

step 3: if the pending FIFO queue of the push operation is not empty, performing the push operation to complete a flow pushing operation.

Preferably, in the step 101, coordinate system conversion is implemented as follows:

if ceil(X/h) is an odd number and ceil(Y/w) is an odd number,

$$\{ \begin{matrix}x = X - ( ceil ( \frac{X}{h} ) - 1 ) * h \\ y = Y - ( ceil ( \frac{Y}{w} ) - 1 ) * w\end{matrix} ;$$

if ceil(X/h) is an odd number and ceil(Y/w) is an even number,

$$\{ \begin{matrix}x = X - ( ceil ( \frac{X}{h} ) - 1 ) * h \\ y = ceil ( \frac{Y}{w} ) * w - Y\end{matrix} ;$$

if ceil(X/h) is an even number and ceil(Y/w) is an odd number,

$$\{ \begin{matrix}x = ceil ( \frac{X}{h} ) * h - X \\ y = Y - ( ceil ( \frac{Y}{w} ) - 1 ) * w\end{matrix} ;$$

or

if ceil(X/h) is an even number and ceil(Y/w) is an even number,

$$\{ \begin{matrix}x = ceil ( \frac{X}{h} ) * h - X \\ y = ceil ( \frac{Y}{w} ) * w - Y\end{matrix} .$$

Preferably, in the step 3, the push operation includes the following steps:

step 301: reading a node with ef data greater than 0 from the FIFO queue dedicated to the push operation, and notifying all pointing nodes whose edge capacity data is greater than 0 to send h data of the pointing nodes back to the current node;

step 302: after a surrounding node returns h data, determining, based on a height of the current node, whether a height of the surrounding node is hcurrent−1; if the condition is met, pushing ef data stored in the current node to all surrounding nodes that meet the condition; assuming that a pushed flow is set to flow, updating data in the current node as follows: ef=ef−flow, and edge=edge−flow; and after receiving the flow, updating, by the surrounding node, data of the surrounding node as follows: ef=ef+flow, and edge=edge+flow; and

step 303: after completing data processing in the FIFO queue dedicated to the push operation, completing the push operation, such that all processor units enter a reset stage, traverse all nodes in the grid graph, and reset h data of all the nodes to 0; then performing the global relabel operation in the step 2; and if the FIFO queue dedicated to the push operation is empty after the global relabel operation is completed, terminating an algorithm.

Compared with the prior art, the present disclosure has following innovative points:

1) The present disclosure folds a single-layer large two-dimensional grid graph into a multi-layer small grid graph. This method has two benefits: A folding grid architecture can store and process a grid graph that is much larger than a processor array in size. The folding grid architecture also endows a two-dimensional processor array with a degree of freedom in a vertical direction, such that the two-dimensional processor array can leverage a potential for parallel performance of the folding grid architecture based on the degree of freedom in the vertical direction. The folding grid architecture proposed in the present disclosure enables a small-sized processor array to have an ability to process a grid graph that is much larger than the small-sized processor array in size. In addition, based on axial symmetry of folding, the folding grid architecture can greatly reduce cross-boundary transmission of data in the processor array, thereby reducing an additional overhead caused by data movement.

2) The present disclosure further provides a disordered parallel execution technology, which can fully tap the potential for the parallel performance of the folding grid architecture. By using an ability of each processor unit to simultaneously access the multi-layer small grid graph, the disordered parallel execution technology detects a node that needs to be computed in the multi-layer grid graph, and temporarily stores data that needs to be computed in a FIFO queue in an FPGA to implement the disordered parallel execution technology.

### BRIEF DESCRIPTION OF THE DRAWINGS

FIG. 1 illustrates a data storage format in a folding grid architecture, where (a) shows an 8×8 grid graph; (b) shows a 4×4 processor array that stores the grid graph in (a), with a number on each processor unit representing a node of the graph that the processor unit stores; and (c) is a schematic diagram of data storage by the folding grid architecture;

FIG. 2 is a schematic diagram of a folding grid architecture for a 4×4 processor array;

FIG. 3 is a schematic flowchart of sequential processing of each processor unit, where an arrow indicates data exchange, a finger points to a small grid graph currently being processed by a processor, a dark gray represents a corresponding node being processed, IDLE represents a currently idle processor, and a light gray represents a to-be-processed node;

FIG. 4 is a schematic execution diagram of running an 8×8 grid graph under a disordered parallel execution technology, where a number in (a) represents a depth of a FIFO queue within each processor unit in a 4×4 processor array, (b) is a processing flowchart of each processor unit, with an arrow indicating data exchange, different gray scales represent processing of 4×4 small grid graphs of different layers (see FIG. 1 for details), and in each iteration, an uppermost triangle symbol represents header data of the FIFO queue, a square represents tail data, and white represents no processing task; and

FIG. 5 shows an execution status of an accelerator.

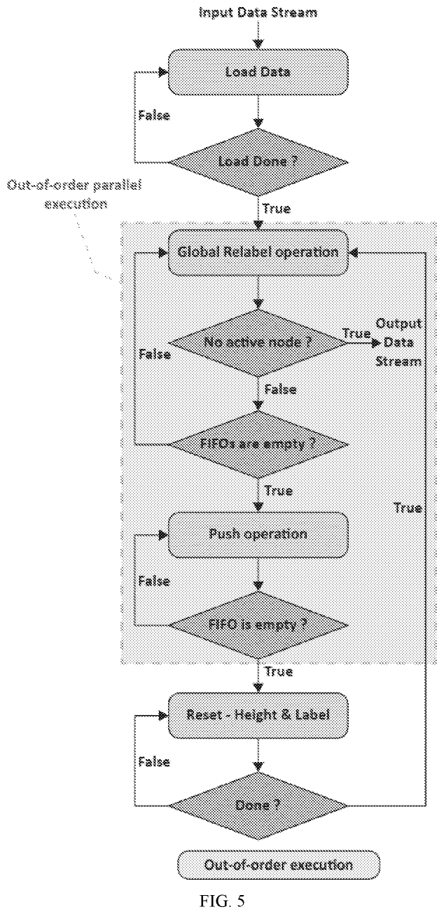

### DETAILED DESCRIPTION OF THE EMBODIMENTS

The present disclosure will be further described below with reference to specific embodiments. It should be understood that these embodiments are only intended to describe the present disclosure, rather than to limit the scope of the present disclosure. In addition, it should be understood that various changes and modifications may be made on the present disclosure by those skilled in the art after reading the content of the present disclosure, and these equivalent forms also fall within the scope defined by the appended claims of the present disclosure.

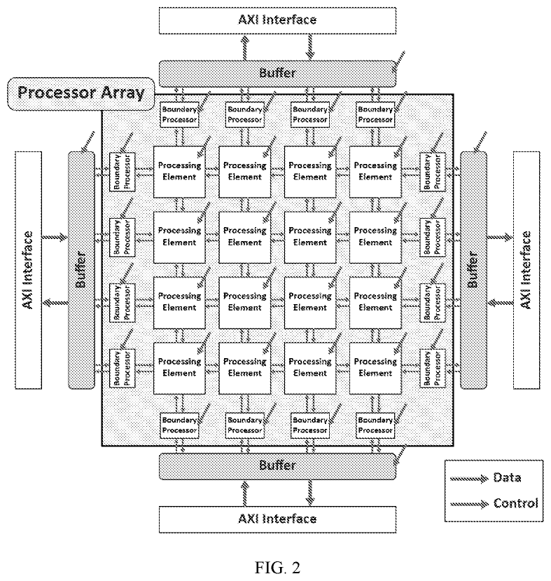

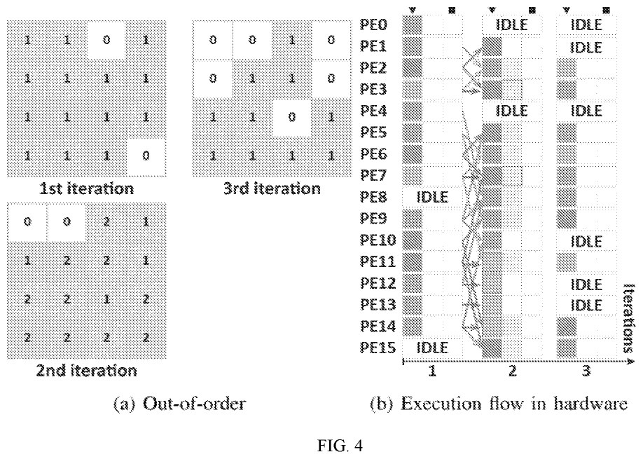

An architecture implemented by an algorithm disclosed in the embodiments on an FPGA is shown in FIG. 2, and a working process of an accelerator is shown in FIG. 4. A specific process is as follows:

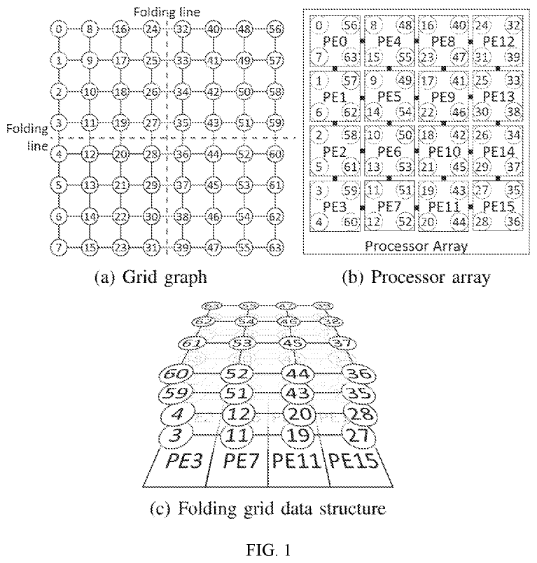

Step 1: Firstly, a large grid graph as shown in FIG. 1 (a) needs to be preprocessed based on a size of a processor array to obtain a folding grid data structure. Assuming that (H, W) is set to a size of the grid graph, (h, w) is set to a size of the processor array, and (X, Y) is set to coordinates of a node in the grid graph, where X∈[1, H], and Y∈[1, W], the preprocessing includes the following steps:

The grid graph is folded based on the size of the processor array. The coordinates (X, Y) of the node in the grid graph are converted into (x, y) in a coordinate system of the processor array, where x∈[1, h], and y∈[1, w]. A conversion method is as follows:

If ceil (X/h) is an odd number and ceil(Y/w) is an odd number, where ceil(a) represents an operation of returning a minimum integer greater than or equal to a (for example, ceil(0.1)=1), class a) is available, and the conversion is performed as follows:

$$\{ \begin{matrix}x = X - ( ceil ( \frac{X}{h} ) - 1 ) * h \\ y = Y - ( ceil ( \frac{Y}{w} ) - 1 ) * w\end{matrix}$$

If ceil is an odd number and ceil is an even number, class b) is available, and the conversion is performed as follows:

$$\{ \begin{matrix}x = X - ( ceil ( \frac{X}{h} ) - 1 ) * h \\ y = ceil ( \frac{Y}{w} ) * w - Y\end{matrix}$$

If ceil(X/h) is an even number and ceil(Y/w) is an odd number, class c) is available, and the conversion is performed as follows:

$$\{ \begin{matrix}x = ceil ( \frac{X}{h} ) * h - X \\ y = Y - ( ceil ( \frac{Y}{w} ) - 1 ) * w\end{matrix}$$

If ceil(X/h) is an even number and ceil(Y/w) is an even number, class d) is available, and the conversion is performed as follows:

$$\{ \begin{matrix}x = ceil ( \frac{X}{h} ) * h - X \\ y = ceil ( \frac{Y}{w} ) * w - Y\end{matrix}$$

After the conversion according to the above method, all nodes in a large grid graph are folded and mapped onto a multi-layer small grid graph that has a same size as the processor array. In the above formulas, the class a) indicates that data does not need to be mirrored or inverted, the class b) indicates that the data needs to be mirrored along a y-axis, the class c) indicates that the data needs to be mirrored along an x-axis, and the class d) indicates that the data needs to be mirrored along the x-axis before being mirrored along the y-axis.

Afterwards, based on converted coordinates of the processor array, data of the grid graph is input into an accelerator. In addition, (h, w), ceil(X/h), and ceil(Y/w) are input as parameters. The (h, w) is used to initialize a specific clock delay in an input/output process of the accelerator. The ceil(X/h) and the ceil(Y/w) are used to determine whether currently processed node data is mirrored. In addition, coordinates [ceil(X/h), ceil(Y/w)] can also represent a specific layer of the multi-layer small grid graph. Because coordinates of each node in each layer of the small grid graph are the size of the processor array, nodes corresponding to same coordinates in the grid graph are stored in a same processor. For example, nodes 27, 28, 35, and 36 in FIG. 1 (a) are all stored in nodes of processor PE15. When a node in the processor PE15 has data exchange with a node in another layer, there is no need to collaborate with another processor in this architecture. Therefore, this design does not require collaborative work of a plurality of processors for cross-layer data transmission in a non-folding architecture, but only requires a single processor to complete this operation internally, thereby reducing additional overheads in time and hardware resources.

Step 2: Firstly, in the grid graph, each node not only contains ef data about a maximum flow that the node accommodates, edge data about a capacity of an edge pointing to a surrounding node, and node height data (h data), but also contains sink data about a capacity of an edge pointing to a virtual sink. The above data is stored in a corresponding processor in order of the coordinates of the processor array in an input stage. After the accelerator loads all the data, a global relabel operation is performed, which is specifically as follows:

All the nodes in the grid graph are traversed. If sink data of a node is greater than 0, the node is initialized as a seed point and its h data is set to 1.

Afterwards, the seed point is used as a root node, all nodes within the root nodes that are pointing to an edge are traversed, and each node within the root nodes that are pointing to an edge notifies surrounding nodes that the node is a root node.

After receiving data, the surrounding node reads a capacity of an edge pointing to the root node. If the capacity is greater than 0, the surrounding node is added to a tree of the root node, and h data of the surrounding node is set to a height of the root node (which is represented as hroot) plus 1.

The global relabel operation repeats the above operation of the root node until the grid graph has no node that can grow and be added to the tree, and then the global relabel operation stops.

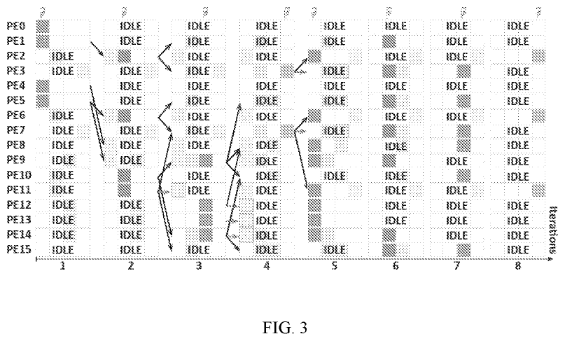

In existing technologies, sequential execution is to synchronize the processor array to cyclically execute each layer of the small grid graph. In an execution process, data transmitted across layers is not transmitted until a corresponding layer is executed. An execution process of a processor unit is shown in FIG. 3. When each layer of the small grid graph is sequentially processed, there are a large number of idle processors. Therefore, the present disclosure provides a FIFO-based disordered execution technology, which achieves cross-layer processing for the multi-layer stacked small grid graph in the folding grid architecture in the step 1.

For example, in the disordered execution technology, when the global relabel operation is performed, all the nodes in the grid graph are traversed. If sink data of a node in the grid graph is not 0, the node is initialized as the seed point. All seed points are put into a FIFO queue. One node is taken from the FIFO queue each time for computing, and a height h1 of a current node is updated to a height h0 read from the FIFO queue plus 1. If data of an edge that is of the current node and points to a buffer node in the FIFO queue is greater than 0, this node grows. Therefore, each processor unit can independently perform cross-layer data transmission and is no longer limited to synchronous sequential execution. At a macro level, each processor is executing nodes in different layers of the small grid graph in disorder, as shown in FIG. 4 (b). This significantly shortens a cycle required to complete a task and improves a usage rate of the processor. When FIFO queues in all processor nodes are empty, the global relabel operation is completed. In an execution process, if ef data in a node is greater than 0, the node is stored in a pending FIFO queue of a push operation in a next stage.

Step 3: If the pending FIFO queue of the push operation is not empty, the push operation is performed to complete a flow pushing operation. The push operation includes: reading a node with ef data greater than 0 from the FIFO queue dedicated to the push operation, and notifying all pointing nodes whose edge capacity data is greater than 0 to send h data of the pointing nodes back to the current node. After a surrounding node returns h data, based on a height of the current node, whether a height of the surrounding node is hcurrent−1 is determined. If the condition is met, ef data of a flow stored in the current node is pushed to all surrounding nodes that meet the condition. Assuming that the pushed flow is set to flow, data in the current node is updated as follows: ef=ef−flow, and edge=edge−flow. After receiving the flow, the surrounding node updates its data as follows: ef=ef+flow, and edge=edge+flow. After data processing in the FIFO queue dedicated to the push operation is completed, the push operation is completed. In this way, all processor units enter a reset stage, traverse all the nodes in the grid graph, and reset h data of all the nodes to 0. Then the global relabel operation in the step 2 is performed. If the FIFO queue dedicated to the push operation is empty after the global relabel operation is completed, the algorithm is terminated.

In the end, compared with a most advanced maximum flow/minimum cut accelerator, the design in the present disclosure increases a usage rate of the processor unit by up to 8.35 times through disordered parallel execution during the global relabel operation. In addition, in terms of simultaneously executing image segmentation tasks in datasets Middlebury and DAVIS2016, the design of the present disclosure is 5.4 times faster than a most advanced accelerator on an FPGA platform.

The above technical solutions can be used for a maximum/minimum cut task that requires a low power consumption and low real-time processing performance. This architecture is not only suitable for an FPGA design, but also for an ASIC design.

What is claimed is:

1. A disordered parallel maximum flow/minimum cut method implemented by an energy-efficient field-programmable gate array (FPGA), comprising the following steps:
step 1: preprocessing a grid graph based on a size of a processor array to obtain a folding grid data structure, and setting (H, W) to a size of the grid graph, (h, w) to a size of the processor array, and (X, Y) to coordinates of a node in the grid graph, wherein X∈[1, H], and Y∈[1, W], such that the preprocessing comprises the following steps:
step 101: converting the coordinates (X, Y) of the node in the grid graph into coordinates (x, y) in a coordinate system of the processor array, wherein x∈[1, h] and y∈[1, w]; and after the coordinate conversion, folding all nodes in a large grid graph and mapping all the nodes onto a multi-layer small grid graph that has a same size as the processor array; and
step 102: based on the converted node coordinates in the coordinate system of the processor array, inputting data of the multi-layer small grid graph obtained in the step 101 into an accelerator, storing a grid graph node corresponding to the same coordinates in a same processor, and inputting (h, w), ceil(X/h), and ceil(Y/w) as parameters, wherein ceil(a) represents an operation of returning a minimum integer greater than or equal to a, the (h, w) is used to initialize a specific clock delay in an input/output process of the accelerator, the ceil(X/h) and the ceil(Y/w) are used to determine whether currently processed node data is mirrored, and coordinates [ceil(X/h), ceil(Y/w)] are used to represent a specific layer of the multi-layer small grid graph;
step 2: storing following data of each node in the multi-layer small grid graph in a corresponding processor in order of coordinates of the processor array in an input stage: ef data about a maximum flow that the node accommodates, edge data about a capacity of an edge pointing to a surrounding node, node height data (h data), and sink data about a capacity of an edge pointing to a virtual sink; and after the accelerator loads all the data, performing a global relabel operation, wherein a processor unit adopts a first in first out (FIFO)-based disordered execution technology to process each layer of the small grid graph, wherein
in the FIFO-based disordered execution technology, the performing a global relabel operation comprises: traversing all nodes in the small grid graph; if sink data about a capacity of a node in the small grid graph is not 0, initializing the node as a seed point, placing all seed points in a FIFO queue, taking one node from the FIFO queue each time for computing, and updating h data of a current node to a height read from the FIFO queue plus 1; if edge data about a capacity of an edge that is of the current node and points to a buffer node in the FIFO queue is greater than 0, growing the node; when FIFO queues in all processor nodes are empty, completing the global relabel operation; and in an execution process, if ef data in a node is greater than 0, storing the node in a pending FIFO queue of a push operation in a next step; and
step 3: if the pending FIFO queue of the push operation is not empty, performing the push operation to complete a flow pushing operation.

2. The disordered parallel maximum flow/minimum cut method implemented by an energy-efficient FPGA according to claim 1, wherein in the step 101, the coordinate system conversion is implemented as follows:
if ceil(X/h) is an odd number and ceil(Y/w) is an odd number,
$$\{ \begin{matrix}x = X - ( ceil ( \frac{X}{h} ) - 1 ) * h \\ y = Y - ( ceil ( \frac{Y}{w} ) - 1 ) * w\end{matrix} ;$$
if ceil(X/h) is an odd number and ceil(Y/w) is an even number,
$$\{ \begin{matrix}x = X - ( ceil ( \frac{X}{h} ) - 1 ) * h \\ y = ceil ( \frac{Y}{w} ) - 1 ) * w - Y\end{matrix} ;$$
if ceil(X/h) is an even number and ceil(Y/w) is an odd number,
$$\{ \begin{matrix}x = ceil ( \frac{X}{h} ) * h - X \\ y = Y - ( ceil ( \frac{Y}{w} ) - 1 ) * w\end{matrix} ;$$
or
if ceil(X/h) is an even number and ceil(Y/w) is an even number,
$$\{ \begin{matrix}x = ceil ( \frac{X}{h} ) * h - X \\ y = ceil ( \frac{Y}{w} ) * w - Y\end{matrix} .$$

3. The disordered parallel maximum flow/minimum cut method implemented by an energy-efficient FPGA according to claim 1, wherein in the step 3, the push operation comprises the following steps:
step 301: reading a node with ef data greater than 0 from the FIFO queue dedicated to the push operation, and notifying all pointing nodes whose edge capacity data is greater than 0 to send h data of the pointing nodes back to the current node;
step 302: after a surrounding node returns h data, determining, based on a height hcurrent of the current node, whether a height of the surrounding node is hcurrent−1; if the condition is met, pushing ef data stored in the current node to all surrounding nodes that meet the condition; assuming that a pushed flow is set to flow, updating data in the current node as follows: ef=ef−flow, and edge=edge−flow; and after receiving the flow, updating, by the surrounding node, data of the surrounding node as follows: ef=ef+flow, and edge=edge+flow; and
step 303: after completing data processing in the FIFO queue dedicated to the push operation, completing the push operation, such that all processor units enter a reset stage, traverse all nodes in the grid graph, and reset h data of all the nodes to 0; then performing the global relabel operation in the step 2; and if the FIFO queue dedicated to the push operation is empty after the global relabel operation is completed, terminating an algorithm.
